(19) United States
(12) Patent Application Publication
(10) Pub. No.: US 2020/0349490 A1
(43) Pub. Date: Nov. 5, 2020

(54) CONTEXT-AWARE INSTRUCTION DELIVERY TO AGENTS

(71) Applicant: Xinova, LLC, Seattle, WA (US)

(72) Inventors: Jin Sam KWAK, Seoul (KR); Min Seok NOH, Seoul (KR); Ju Hyung SON, Seoul (KR)

(73) Assignee: Xinova, LLC, Seattle, WA (US)

(21) Appl. No.: 16/957,365

(22) PCT Filed: Jan. 22, 2018
(86) PCT No.: PCT/US18/14656

§ 371 Date: Jun. 23, 2020

(51) Int. Cl. G06Q 10/06; G06F 21/32; G06F 21/34

(52) U.S. Cl. CPC G06Q 10/06316; G06F 21/34; G06F 21/32; G06Q 10/063114

(57) ABSTRACT

Technologies are provided for context-based instruction delivery to field agents. In some examples, one or more context-sensitive criteria may be extracted from an instruction contained in a message. The message and the criteria may then be transmitted to multiple field agent devices. In response to receiving the message and the criteria, a field agent device may determine whether a legitimate agent is present and the criteria are satisfied. If a legitimate agent is present and the criteria are satisfied, then the agent device may provide the instruction in the message to the legitimate agent. On the other hand, if a legitimate agent is not present, or if the device and/or agent fail the criteria, then the device may ignore the instruction.

### BACKGROUND

Unless otherwise indicated herein, the materials described in this section are not prior art to the claims in this application and are not admitted to be prior art by inclusion in this section.

Large-scale events, such as concerts, sporting events, and conventions, often involve an extensive security presence. Security at such events may be provided by multiple field agents stationed throughout or roaming the event premises and by agents located at one or more command centers. Individual field agents may be able to respond independently to local events, while the command center agents may monitor larger portions of the event and provide instructions to field agents to respond to observed or predicted disturbances.

### SUMMARY

The present disclosure generally describes techniques to have agent devices selectively provide instructions to agents.

According to some examples, a method is provided to enable agent devices to selectively output instructions. The method may include receiving a message from a command center agent and including an instruction, processing the message to extract at least one criterion from the instruction, transmitting the message to multiple field agent devices, and causing the field agent devices to process the message such that a first field agent device that satisfies the at least one criterion outputs the instruction and a second field agent device that fails the at least one criterion ignores the instruction.

According to other examples, an agent device is provided to selectively present instructions to legitimate agents. The agent device may include a memory configured to store information associated with a legitimate agent, a transceiver configured to communicate with a remote server, an output device configured to present information, and a processor coupled to the memory, the transceiver, and the output device. The processor may be configured to perform or control performance of receive, a message from the remote server via the transceiver, where the message includes an instruction and at least one criterion extracted from the instruction, and determine whether the stored information in the memory meets the at least one criterion. The processor may also be configured to perform or control performance of, in response to a determination that the stored information meets the at least one criterion, cause the output device to present the instruction to the legitimate agent, and in response to a determination that the stored information fails the at least one criterion, ignore the instruction.

According to further examples, a method is provided for an agent device to selectively provide instructions to legitimate agents. The method may include receiving a message including an instruction and at least one criterion extracted from the instruction from a remote security server, determining whether a legitimate agent is present, and in response to a determination that the legitimate agent is absent, ignoring the instruction. The method may further include, in response to a determination that the legitimate agent is present, retrieving information associated with the legitimate agent from an agent device memory and determining whether the retrieved information meets the at least one criterion. The method may further include providing the instruction to the legitimate agent in response to a determination that the retrieved information meets the at least one criterion and ignoring the instruction in response to a determination that the retrieved information fails the at least one criterion.

According to yet further examples, a security agent system is provided to enable agent devices to selectively output instructions. The security agent system may include multiple field agent devices, a command agent interface configured to receive messages from a command center agent, a criterion extraction module configured to extract at least one criterion from an instruction, a network interface communicatively coupled to the field agent devices, and a processor coupled to the command agent interface, the criterion evaluation module, and the network interface. The processor may be configured to perform or control performance of receiving a message including the instruction from the command center agent and via the command agent interface, provide the message to the criterion extraction module, receive the at least one criterion from the criterion extract module, and transmit the message and the at least one criterion to the field agent devices via the network interface. A first one of the field agent devices that satisfies the at least one criterion may be configured to process the message and output the instruction, and a second one of the field agent devices that fails the at least one criterion may be configured to ignore the instruction.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an example system where agent devices selectively output instructions to agents based on context;

FIG. 2 illustrates an example scenario in which instructions are selectively output to agents based on conditional and secondary information;

FIG. 3 illustrates an example structure of a message containing a main instruction and conditional/secondary information used to determine whether the main instruction is to be output;

FIG. 4 illustrates a computing device, which may be used to selectively output instructions to agents based on context;

FIG. 5 is a flow diagram illustrating an example method to send context-based instructions to agents that may be performed by a computing device such as the security server in FIG. 1;

FIG. 6 is a flow diagram illustrating an example method to output instructions to agents based on context that may be performed by a computing device such as the computing device in FIG. 4; and

FIGS. 7 and 8 illustrate block diagrams of example computer program products, all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, devices, and/or computer program products related to selective delivery of instructions to agents based on context.

Briefly stated, technologies are generally described for context-based instruction delivery to field agents. In some examples, one or more context-sensitive criteria may be extracted from an instruction contained in a message. The message and the criteria may then be transmitted to multiple field agent devices. In response to receiving the message and the criteria, a field agent device may determine whether a legitimate agent is present and the criteria are satisfied. If a legitimate agent is present and the criteria are satisfied, then the agent device may provide the instruction in the message to the legitimate agent. On the other hand, if a legitimate agent is not present, or if the device and/or agent fail the criteria, then the device may ignore the instruction.

Security at large-scale events such as concerts, competitions, and conventions, may be provided by multiple field agents and by agents at one or more command centers. In these situations, agents at the command centers may find it necessary to provide information and/or instructions relevant to some but not all field agents. For example, agents at the command center may wish to instruct field agents near a particular location to converge on that location. One method by which this can be accomplished is by identifying, at the command center, the relevant field agents, and then providing the instruction to the identified agents. However, this method may be problematic, because the agents at the command center may not have complete status information about field agents and therefore may not be able to identify the relevant field agents.

Another method by which instructions may be provided to relevant field agents is to have the field agents themselves determine relevancy. In order to avoid providing extraneous information and/or providing information to unauthorized personnel, a field agent device associated with each field agent may be configured to determine relevancy based on context and output relevant instructions to authorized personnel.

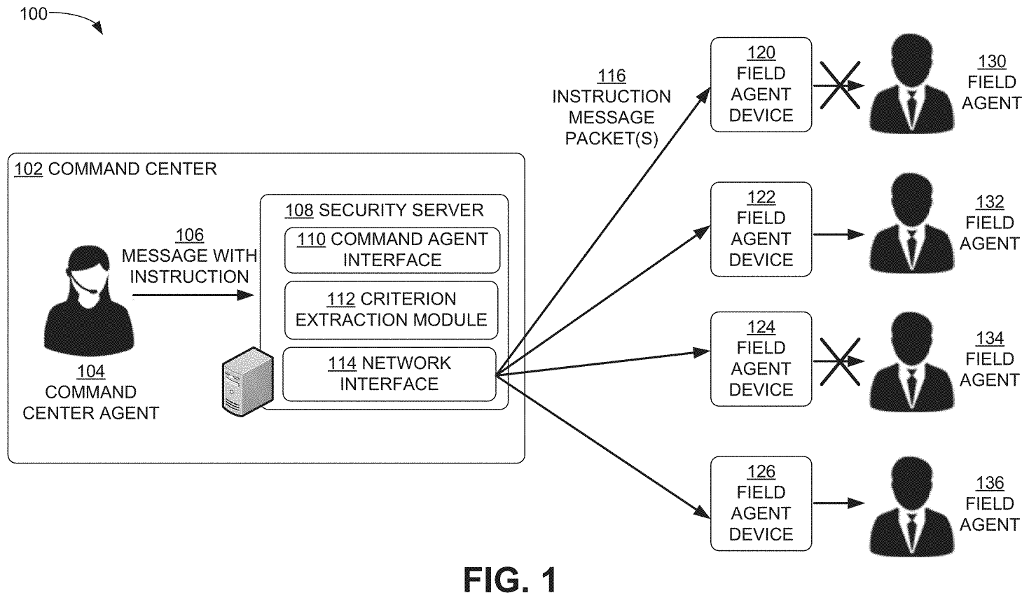

FIG. 1 illustrates an example system 100 where agent devices selectively output instructions to agents based on context, arranged in accordance with at least some embodiments described herein.

System 100 may include a command center 102 configured to communicate with field agents 130-136 via respective field agent devices 120-126. The field agent devices 120-126 may include devices associated with and used by the individual field agents 130-136. For example, the field agent devices 120-126 may include a smartphone, a tablet computer, a wearable computer, a headset, an earpiece, an augmented-reality device, some combination of the previous, or any other device suitable for processing instruction-containing messages and for providing instructions to agents. In some embodiments, a field agent device may be configured to determine whether a legitimate field agent is currently using or in possession of the field agent device, as described below. The command center 102 may include a command center agent 104 and a security server 108. The security server 108 may include or implement a command agent interface 110, a criterion extraction module 112, and a network interface 114, which may be communicatively coupled to each other.

The command agent interface 110 may be configured to receive messages from the command center agent 104, and may be configured to receive messages via textual input (for example, via a keyboard), via audio input (for example, via a microphone and appropriate voice recognition functionality), or via any suitable input source.

The criterion extraction module 112 may be configured to process messages received via the command agent interface 110 to identify instructions contained within the messages and extract relevant contextual criteria associated with the instructions. Contextual criteria may include information associated with the performance of the instructions and/or the context within which the instructions are to be performed. For example, relevant instruction-related contextual criteria may include a location associated with the instructions, a distance or range from the location, an agent assignment that may be relevant to the instructions, an agent equipment that may be necessary to perform the instructions, an agent capability that may be necessary to perform the instructions, an agent condition that may be necessary to perform the instructions, an agent affiliation suitable for performance of the instructions, an agent environment relevant to the instructions, or any other suitable criterion (or combination thereof) relevant to the instructions. The criterion extraction module 112 may be configured to extract criteria from received messages using any suitable technique, such as speech recognition, natural language processing, machine learning, or any other suitable information-extraction method.

The network interface 114 may be communicatively coupled to the field agent devices 120-126, and may be configured to transmit to and/or receive information from the field agent devices 120-126. The network interface 114 may operate via a wireless or wired connection, and may use any suitable communication protocol. The network interface 114 may be implemented at least in part, for example, by a transceiver.

In the course of providing security, the command center agent 104 may provide a message 106 containing an instruction to the security server 108 for distribution to the field agents 130-136, via the command agent interface 110. In response to receiving the message 106, the security server 108 may pass the message 106 to the criterion extraction module 112, which may then extract from the message 106 one or more instructions and one or more criteria associated with the instructions, as described above. The security server 108 may package the extracted instructions and criteria into one or more instruction message packet(s) 116 intended for the field agents 130-136, and may then provide the message to the network interface 114. The network interface 114 may then transmit the instruction message packet(s) 116 to the field agent devices 120-126.

The field agent devices 120-126 may process the instruction message packet(s) 116 to extract the packaged criteria. Each of the field agent devices 120-126 may first determine whether a legitimate or authorized agent is present, in possession of, and/or currently using the field agent device. In some embodiments, a field agent device may determine that a legitimate agent is present or using the field agent device based on a detected acoustic feature (for example, the voice of a field agent), another agent biometric signal (for example, a fingerprint, retinal scan, physical movement pattern, posture, etc.), an agent-provided password or passphrase, a proximity signal (for example, to determine whether a person is near, holding, and/or wearing the field agent device), and/or an illuminance signal (for example, via a light signal that is blocked or absorbed when a person is near, holding, and/or wearing the field agent device).

After determining that a legitimate agent is present, or in parallel with the presence determination, each of the field agent devices 120-126 may determine whether the extracted criteria are satisfied. For example, as described above, relevant instruction-related criteria may include a location, a distance or range from a location, an agent assignment, an agent equipment, an agent capability, an agent condition, an agent affiliation, the environment that surrounds the agent, or any other suitable criterion. A field agent device may store this information in a field agent device memory, or may include or have access to sensors to determine this information. To determine whether the extracted criteria are satisfied, a field agent device may compare the extracted criteria to the information stored at and/or sensed by the field agent device.

If the field agent device determines that a legitimate agent is not present, or if the field agent device determines that the device and/or the field agent fails one or more of the extracted criteria, then the field agent device may ignore the instruction(s) included in the received message. For example, the field agent devices 120 and 124 may determine that they or the field agents 130 and 134 fail one or more of the criteria extracted from the instruction message packet(s) 116, and in response, ignore the instructions in the instruction message packet(s) 116. The field agent devices 120 and 124 may discard the instruction message packet(s) 116, or may store the instruction message packet(s) 116 and later again determine whether a legitimate agent is present and/or whether the one or more criteria are satisfied.

If the field agent device instead determines that a legitimate agent is present and the one or more extracted criteria are satisfied, then the field agent device may extract the instruction(s) included in the received message and send the extracted instruction(s) to the field agent. For example, the field agent devices 122 and 126 may determine that they and the field agents 132 and 136 satisfy the criteria extracted from the instruction message packet(s) 116. In response, the field agent devices 122 and 126 may extract the instruction(s) included in the instruction message packet(s) 116 and send the extracted instruction(s) to the field agents 132 and 136. The field agent devices 122 and 126 may send the extracted instruction(s) to the field agents 132 and 136 as text, images, audio, and/or via some other format(s) or combination(s) thereof.

As described above, when a field agent device receives an instruction message packet, the field agent device may determine whether to output instructions included in the instruction message packet to a legitimate field agent based on whether criteria included in the instruction message packet are satisfied. In some embodiments, the criteria may be categorized into conditional and/or secondary information, where conditional information is a base criterion (for example, a particular location, a particular piece of equipment, etc.) and secondary information modifies the conditional information. For example, if conditional information includes a location, secondary information may include a distance or range from the location.

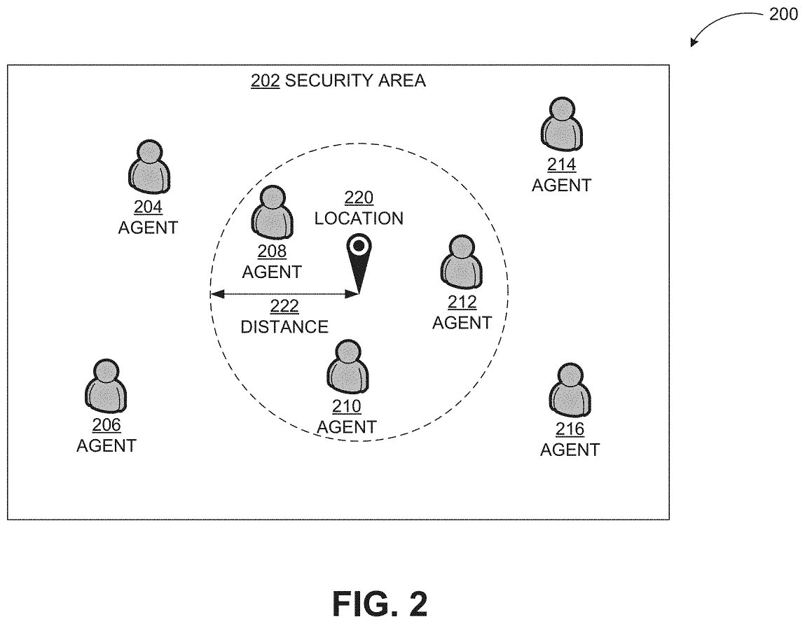

FIG. 2 illustrates an example scenario 200 in which instructions are selectively output to agents based on conditional and secondary information, arranged in accordance with at least some embodiments described herein.

In scenario 200, field agents 204-216 may be present and monitoring a security area 202. Each of the field agents 204-216 may receive an instruction message packet with conditional information specifying a location 220 and secondary information specifying a distance or range 222, where the instruction is to approach the location 220. The conditional and secondary information may serve as criteria, and field agents that satisfy the criteria may be provided with the instruction. After receiving the instruction message packet, each field agent (or their corresponding field agent devices) may determine whether the criteria are satisfied. As depicted in the scenario 200, field agents 204, 206, 214, and 216 may not be within distance 222 of location 220. Accordingly, the field agent devices of field agents 204, 206, 214, and 216 may not provide the instruction to approach the location 220 to their associated field agents. Also depicted in the scenario 200, field agents 208-212 may be within distance 222 of location 220. Accordingly, the field agent devices of field agents 208-212 may provide the instruction to approach the location 220 to their associated field agents.

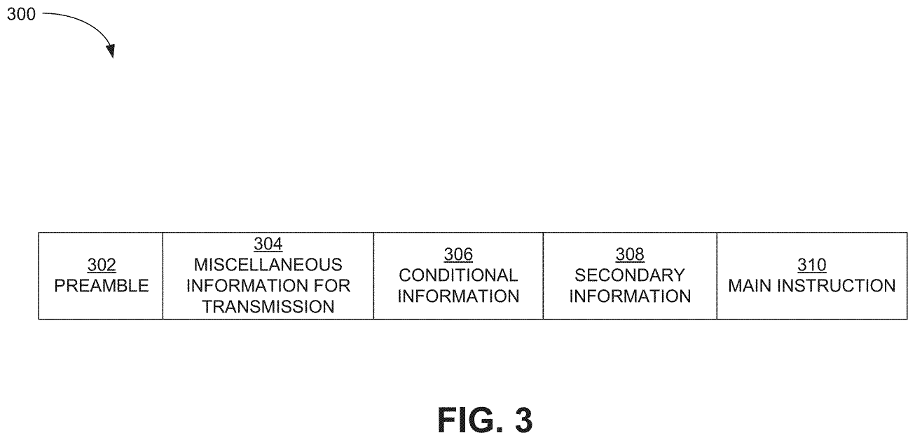

FIG. 3 illustrates an example structure of a message 300 containing a main instruction and conditional/secondary information used to determine whether the main instruction is to be output, arranged in accordance with at least some embodiments described herein.

As depicted in FIG. 3, the message 300 may include a preamble field 302, a miscellaneous information field 304, a conditional information field 306, a secondary information field 308, and a main instruction field 310, although in other embodiments a message may include more or fewer fields or combined fields. The preamble field 302 may include information about how a receiving device such as a field agent device is to interpret the remainder of the message 300, such as signal waveform shape, signal waveform timing, and the like. The miscellaneous information for transmission field 304 may include information about the type of the message 300, for example whether the message 300 is a command, what kind of command the message 300 is, command-related parameters associated with the message 300, and/or any other suitable information for a receiving device to process the remainder of the message 300. The conditional information field 306 and the secondary information field 308 may include conditional information and secondary information, respectively, as described above. In some embodiments, only conditional information may be included, in which case the secondary information field 308 may be empty or omitted. The main instruction field 310 may include one or more instructions as described above.

In other embodiments, at least a portion of the message 300 may be secured such that an unauthorized entity cannot recover information within the portion. For example, the conditional information field 306, the secondary information field 308, and/or the main instruction field 310 may be encrypted or otherwise obscured in some fashion. A receiving device that is authorized to receive the message 300 may have knowledge of a cryptographic key, cryptographic algorithm, and/or obscuring technique used to secure the message 300, and may use that knowledge to recover information from the secured portions if appropriate. For example, if a field agent device determines that no legitimate field agents are present, the field agent device may not recover information from any of the fields 306-310. If the field agent device determines that a legitimate field agent is present, the field agent device may recover information from the conditional information field 306 and the secondary information field 308 to determine whether the included criteria are satisfied. If the field agent device and/or the legitimate field agent fail the criteria, then the field agent device may not recover information from the main instruction field 310. On the other hand, if the field agent device and/or the legitimate field agent satisfy the criteria, then the field agent device may recover information from the main instruction field 310 and send the recovered information to the legitimate field agent.

The examples provided in FIGS. 1 through 3 are illustrated with specific systems, scenarios, and structures. Embodiments are not limited to environments according to these examples. Selective output of instructions to field agents based on context may be implemented in environments employing fewer or additional systems, scenarios, and structures. Furthermore, the example systems, scenarios, and structures shown in FIGS. 1 through 3 may be implemented in a similar manner with other user interface or action flow sequences using the principles described herein.

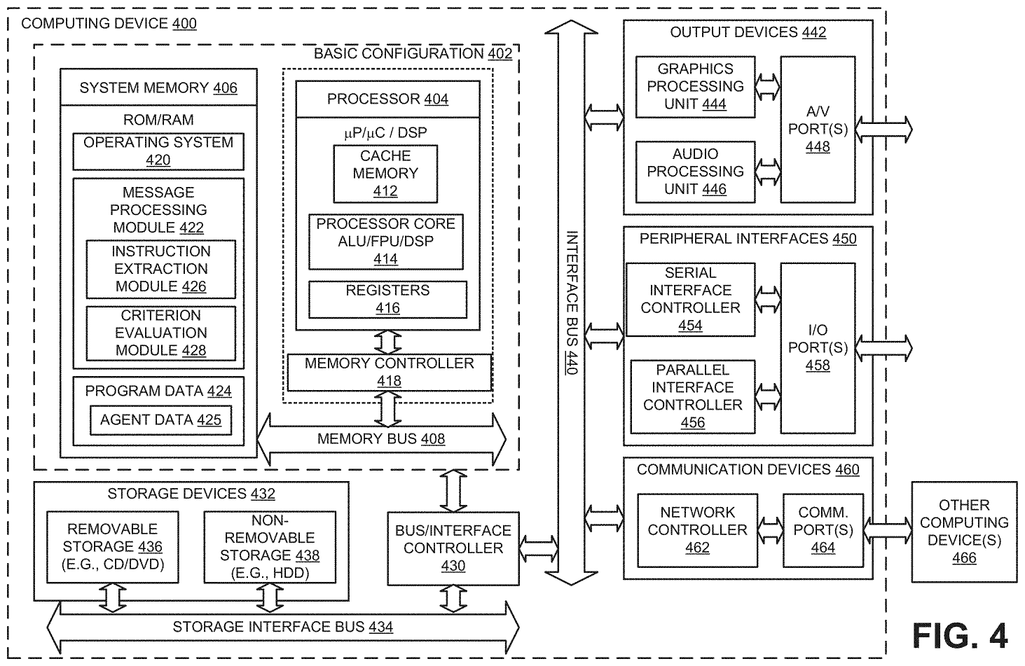

FIG. 4 illustrates a computing device, which may be used to selectively output instructions to agents based on context, arranged in accordance with at least some embodiments described herein.

For example, the computing device 400 may be used to extract criteria, evaluate the extracted criteria, and output instructions based on the evaluation. In an example basic configuration 402, the computing device 400 may include one or more processors 404 and a system memory 406. A memory bus 408 may be used to communicate between the processor 404 and the system memory 406. The basic configuration 402 is illustrated in FIG. 4 by those components within the inner dashed line.

Depending on the desired configuration, the processor 404 may be of any type, including but not limited to a microprocessor (μP), a microcontroller (μC), a digital signal processor (DSP), or any combination thereof. The processor 404 may include one or more levels of caching, such as a cache memory 412, a processor core 414, and registers 416. The example processor core 414 may include an arithmetic logic unit (ALU), a floating point unit (FPU), a digital signal processing core (DSP core), or any combination thereof. An example memory controller 418 may also be used with the processor 404, or in some implementations, the memory controller 418 may be an internal part of the processor 404.

Depending on the desired configuration, the system memory 406 may be of any type including but not limited to volatile memory (such as RAM), non-volatile memory (such as ROM, flash memory, etc.) or any combination thereof. The system memory 406 may include an operating system 420, a message processing module 422, and program data 424. The message processing module 422 may include an instruction extraction module 426 and a criterion evaluation module 428, configured to extract instructions and criteria from a received message and evaluate whether the criteria are satisfied, as described herein. The criterion extraction module 112 may be implemented by either or both the instruction extraction module 426 and the criterion evaluation module 428, in some embodiments. The program data 424 may include, among other data, agent data 425 or the like, as described herein.

The computing device 400 may have additional features or functionality, and additional interfaces to facilitate communications between the basic configuration 402 and any desired devices and interfaces. For example, a bus/interface controller 430 may be used to facilitate communications between the basic configuration 402 and one or more data storage devices 432 via a storage interface bus 434. The data storage devices 432 may be one or more removable storage devices 436, one or more non-removable storage devices 438, or a combination thereof. Examples of the removable storage and the non-removable storage devices include magnetic disk devices such as flexible disk drives and hard-disk drives (HDDs), optical disk drives such as compact disc (CD) drives or digital versatile disk (DVD) drives, solid state drives (SSDs), and tape drives to name a few. Example computer storage media may include volatile and nonvolatile, removable and non-removable media implemented in any method or technology for storage of information, such as computer readable instructions, data structures, program modules, or other data.

The system memory 406, the removable storage devices 436 and the non-removable storage devices 438 are examples of computer storage media. Computer storage media includes, but is not limited to, RAM, ROM, EEPROM, flash memory or other memory technology, CD-ROM, digital versatile disks (DVDs), solid state drives (SSDs), or other optical storage, magnetic cassettes, magnetic tape, magnetic disk storage or other magnetic storage devices, or any other medium which may be used to store the desired information and which may be accessed by the computing device 400. Any such computer storage media may be part of the computing device 400.

The computing device 400 may also include an interface bus 440 for facilitating communication from various interface devices (e.g., one or more output devices 442, one or more peripheral interfaces 450, and one or more communication devices 460) to the basic configuration 402 via the bus/interface controller 430. Some of the example output devices 442 include a graphics processing unit 444 and an audio processing unit 446, which may be configured to communicate to various external devices such as a display or speakers via one or more A/V ports 448. One or more example peripheral interfaces 450 may include a serial interface controller 454 or a parallel interface controller 456, which may be configured to communicate with external devices such as input devices (e.g., keyboard, mouse, pen, voice input device, touch input device, etc.) or other peripheral devices (e.g., printer, scanner, etc.) via one or more I/O ports 458. The command agent interface 110 may be implemented in some embodiments by the peripheral interface(s) 450. An example communication device 460 includes a network controller 462, which may be arranged to facilitate communications with one or more other computing devices 466 over a network communication link via one or more communication ports 464. In one embodiment, the network interface 114 may be implemented at least in part by the communication device 460. The one or more other computing devices 466 may include servers at a datacenter, customer equipment, and comparable devices.

The network communication link may be one example of a communication media. Communication media may be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 400 may be implemented as a part of a general purpose or specialized server, mainframe, or similar computer that includes any of the above functions. The computing device 400 may also be implemented as a personal computer including both laptop computer and non-laptop computer configurations.

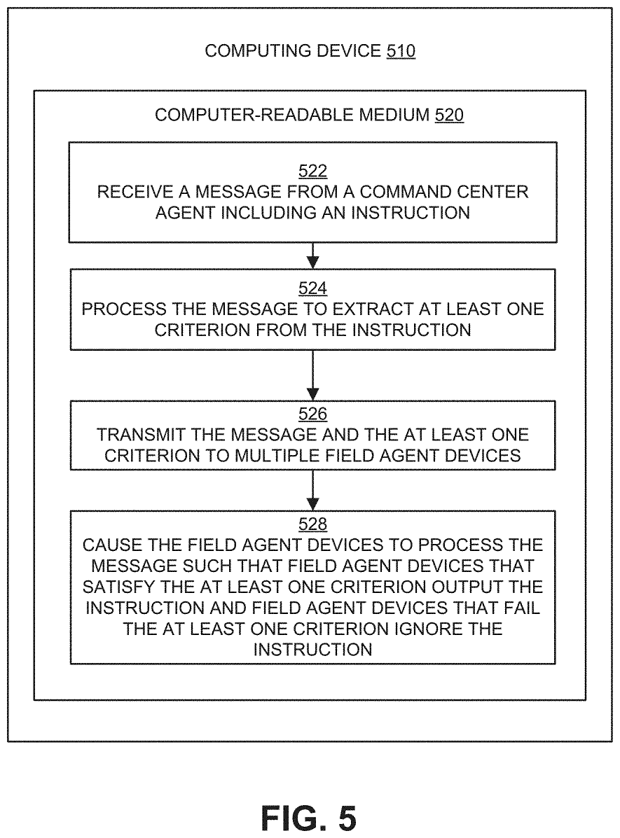

FIG. 5 is a flow diagram illustrating an example method to send context-based instructions to agents that may be performed by a computing device such as the security server in FIG. 1, arranged in accordance with at least some embodiments described herein.

Example methods may include one or more operations, functions, or actions as illustrated by one or more of blocks 522, 524, 526, and/or 528, and may in some embodiments be performed by a computing device such as the security server 108 in FIG. 1. Such operations, functions, or actions in FIG. 5 and in the other figures, in some embodiments, may be combined, eliminated, modified, and/or supplemented with other operations, functions or actions, and need not necessarily be performed in the exact sequence as shown. The operations described in the blocks 522-528 may also be implemented through execution of computer-executable instructions stored in a computer-readable medium such as a computer-readable medium 520 of a computing device 510.

An example process to send context-based instructions to agents may begin with block 522, “RECEIVE A MESSAGE FROM A COMMAND CENTER AGENT INCLUDING AN INSTRUCTION”, where a security server such as the security server 108 may receive, from a command center agent, a message containing an instruction. The security server may receive the message via an agent interface, in the form of text, voice, or any other suitable input, as described above.

Block 522 may be followed by block 524, “PROCESS THE MESSAGE TO EXTRACT AT LEAST ONE CRITERION FROM THE INSTRUCTION”, where the security server processes the received message to extract one or more criteria from the instruction and/or the message, as described above. For example, the security server may use a criterion extraction module to extract the criteria from the instruction and/or message. The criteria may include conditional and/or secondary information, as described above.

Block 524 may be followed by block 526, “TRANSMIT THE MESSAGE AND THE AT LEAST ONE CRITERION TO MULTIPLE FIELD AGENT DEVICES”, where the security server transmits, for example via a network interface, the message and one or more of the criteria extracted in block 524 to multiple field agent devices, as described above.

Block 526 may be followed by block 528, “CAUSE THE FIELD AGENT DEVICES TO PROCESS THE MESSAGE SUCH THAT FIELD AGENT DEVICES THAT SATISFY THE AT LEAST ONE CRITERION OUTPUT THE INSTRUCTION AND FIELD AGENT DEVICES THAT FML THE AT LEAST ONE CRITERION IGNORE THE INSTRUCTION”, where the security server may cause the field agent devices that receive the message to process the message, for example via information in a miscellaneous information for transmission field in the message as described above. The field agent devices may process the message such that field agent devices that satisfy the at least one criterion output the instruction to an associated field agent, whereas field agent devices that fail the at least one criterion ignore the instruction, as described above.

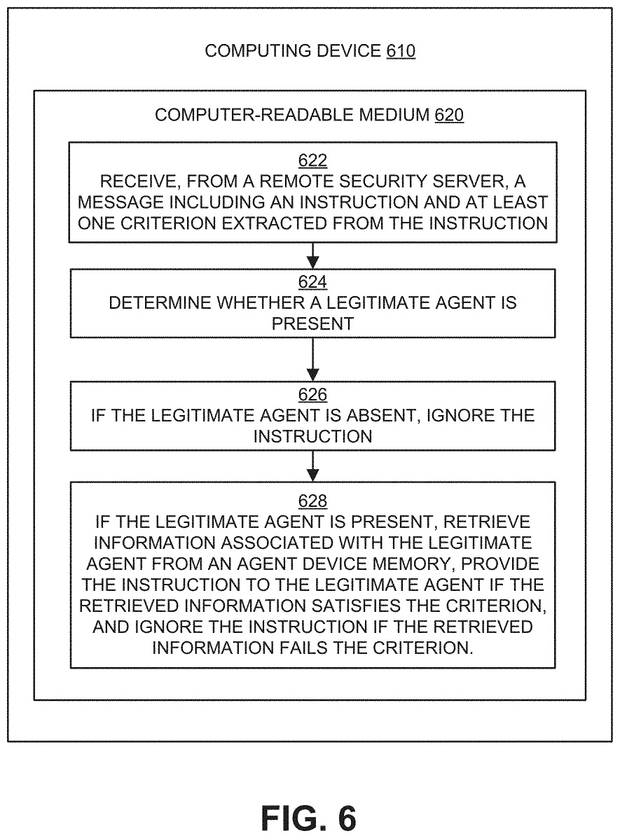

FIG. 6 is a flow diagram illustrating an example method to output instructions to agents based on context that may be performed by a computing device such as the computing device in FIG. 4, arranged in accordance with at least some embodiments described herein.

Example methods may include one or more operations, functions or actions as illustrated by one or more of blocks 622, 624, 626, and/or 628, and may in some embodiments be performed by a computing device such as the computing device 400 in FIG. 4. The operations described in the blocks 622-628 may also be implemented through execution of computer-executable instructions stored in a computer-readable medium such as a computer-readable medium 620 of a computing device 610.

An example process to output instructions to agents based on context may begin with block 622, “RECEIVE, FROM A REMOTE SECURITY SERVER, A MESSAGE INCLUDING AN INSTRUCTION AND AT LEAST ONE CRITERION EXTRACTED FROM THE INSTRUCTION”, where a field agent device may receive a message that includes an instruction and one or more criteria extracted from the message or instruction, as described above. The message may be encrypted or otherwise secured such that an unauthorized entity cannot recover information from the message.

Block 622 may be followed by block 624, “DETERMINE WHETHER A LEGITIMATE AGENT IS PRESENT”, where the field agent device may determine whether a legitimate entity or field agent is currently present, in possession of the field agent device, and/or using the field agent device. In some embodiments, the field agent device may determine presence using a detected acoustic feature, biometric signal, a password or passphrase, a proximity signal, an illuminance signal, or any other suitable method, as described above.

Block 624 may be followed by block 626, “IF THE LEGITIMATE AGENT IS ABSENT, IGNORE THE INSTRUCTION”, where if the field agent device determines that a legitimate agent is not currently present, in possession of the field agent device, or using the field agent device, the field agent device may ignore the instruction and/or the remainder of the message. The field agent device may discard the message, or may store the message and later attempt to determine whether the legitimate agent is present.

Block 626 may be followed by block 628, “IF THE LEGITIMATE AGENT IS PRESENT, RETRIEVE INFORMATION ASSOCIATED WITH THE LEGITIMATE AGENT FROM AN AGENT DEVICE MEMORY, PROVIDE THE INSTRUCTION TO THE LEGITIMATE AGENT IF THE RETRIEVED INFORMATION SATISFIES THE CRITERION, AND IGNORE THE INSTRUCTION IF THE RETRIEVED INFORMATION FAILS THE CRITERION”, where if the field agent device determines that a legitimate agent is present, in possession of the field agent device, and/or using the field agent device, the field agent device may then determine whether the field agent device and/or the legitimate agent satisfies the extracted criteria, as described above. In some embodiments, the field agent device may retrieve information associated with the legitimate agent from a field agent device memory and compare the retrieved information with the extracted criteria. If the retrieved information satisfies the criteria, then the field agent device may provide the instruction to the legitimate agent. If the retrieved information fails the criteria, then the field agent device may ignore the instruction. In some embodiments, the field agent device may then either discard the message or may store the message and later attempt to determine whether the criteria are satisfied.

The operations included in the example processes of FIG. 5 and FIG. 6 are for illustration purposes. Providing context-based instructions to agents may be implemented by similar processes with fewer or additional operations, as well as in different order of operations using the principles described herein. The operations described herein may be executed by one or more processors operated on one or more computing devices, one or more processor cores, specialized processing devices, and/or general purpose processors, among other examples.

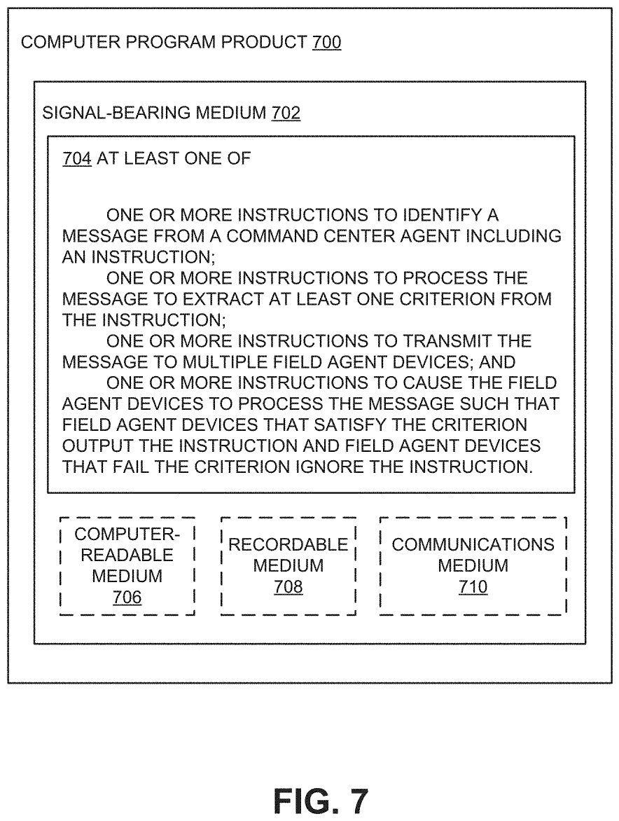

FIG. 7 illustrates a block diagram of an example computer program product, arranged in accordance with at least some embodiments described herein.

In some examples, as shown in FIG. 7, a computer program product 700 may include a signal-bearing medium 702 that may also include one or more machine readable instructions 704 that, in response to execution by, for example, a processor may provide the functionality described herein. Thus, for example, referring to the security server 108 in FIG. 1, a processor within the security server 108 may perform or control performance of one or more of the tasks shown in FIG. 7, in response to the instructions 704 conveyed to the processor by the signal-bearing medium 702 to perform actions associated with sending context-based instructions to agents as described herein. Some of those instructions may include, for example, instructions to identify a message from a command center agent including an instruction, instructions to process the message to extract at least one criterion from the instruction, instructions to transmit the message to multiple field agent devices, and/or instructions to cause the field agent devices to process the message such that field agent devices that satisfy the criterion output the instruction and field agent devices that fail the criterion ignore the instruction, according to some embodiments described herein.

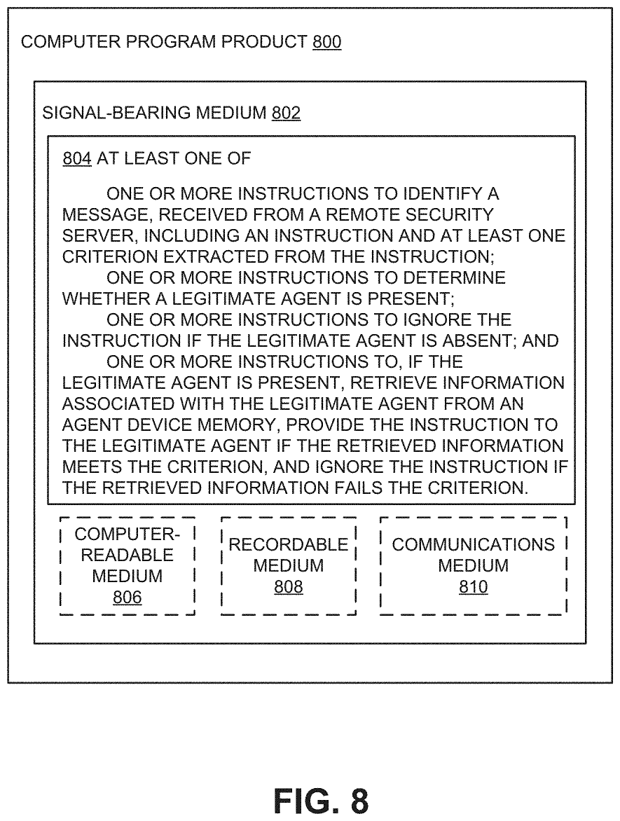

FIG. 8 illustrates a block diagram of another example computer program product, arranged in accordance with at least some embodiments described herein.

In some examples, as shown in FIG. 8, a computer program product 800 may include a signal-bearing medium 802 that may also include one or more machine readable instructions 804 that, in response to execution by, for example, a processor may provide the functionality described herein. Thus, for example, referring to the processor 404 in FIG. 4, the message processing module 422 may perform or control performance of one or more of the tasks shown in FIG. 8, in response to the instructions 804 conveyed to the processor 404 by the signal-bearing medium 802 to perform actions associated with outputting instructions to agents based on context as described herein. Some of those instructions may include, for example, instructions to identify a message, received from a remote security server, including an instruction and at least one criterion extracted from the instruction, instructions to determine whether a legitimate agent is present, instructions to ignore the instruction if the legitimate agent is absent; and/or instructions to, if the legitimate agent is present, retrieve information associated with the legitimate agent from an agent device memory, provide the instruction to the legitimate agent if the retrieved information meets the criterion, and ignore the instruction if the retrieved information fails the criterion, according to some embodiments described herein.

In some implementations, the signal-bearing medium 702 and 802 depicted in FIGS. 7 and 8 may encompass computer-readable medium 706 and 806, such as, but not limited to, a hard disk drive (HDD), a solid state drive (SSD), a compact disc (CD), a digital versatile disk (DVD), a digital tape, memory, etc. In some implementations, the signal-bearing medium 702 and 802 may encompass recordable medium 708 and 808, such as, but not limited to, memory, read/write (R/W) CDs, R/W DVDs, etc. In some implementations, the signal-bearing medium 702 and 802 may encompass communications medium 710 and 810, such as, but not limited to, a digital and/or an analog communication medium (e.g., a fiber optic cable, a waveguide, a wired communication link, a wireless communication link, etc.). Thus, for example, the computer program products 700 and 800 may be conveyed to one or more modules of a processor by an RF signal bearing medium, where the signal-bearing medium 702 and 802 are conveyed by the communications medium 710 and 810 (e.g., wireless communications media conforming with the IEEE 802.11 standard).

According to some examples, a method is provided to enable agent devices to selectively output instructions. The method may include receiving a message from a command center agent and including an instruction, processing the message to extract at least one criterion from the instruction, transmitting the message to multiple field agent devices, and causing the field agent devices to process the message such that a first field agent device that satisfies the at least one criterion outputs the instruction and a second field agent device that fails the at least one criterion ignores the instruction.

According to some embodiments, the method may further include deriving conditional and/or secondary information from the at least one criterion, where the secondary information is arranged to modify the conditional information. A location may be included in the conditional information, and a range from the location may be included in the secondary information. The method may further include causing the first field agent device to determine whether it satisfies the at least one criterion through a comparison of the at least one criterion to information stored by the first field agent device and associated with a legitimate agent. The information may include information about one or more of a location of the legitimate agent, an assignment of the legitimate agent, equipment of the legitimate agent, a capability of the legitimate agent, a condition of the legitimate agent, an affiliation of the legitimate agent, and an environment that surrounds the legitimate agent.

According to other embodiments, the method may further include causing, before outputting the instruction, the first field agent device to determine that a legitimate agent is using the first field agent device. Causing the first field agent device to determine that the legitimate agent is using the first field agent device may include causing the first field agent device to determine that the legitimate agent is using the first agent device based on at least one of a detected acoustic feature, a password, a biometric signal, a proximity signal, and an illuminance signal. Processing the message to extract the at least one criterion may include extracting the at least one criterion from the instruction based on a context of the instruction.

According to other examples, an agent device is provided to selectively present instructions to legitimate agents. The agent device may include a memory configured to store information associated with a legitimate agent, a transceiver configured to communicate with a remote server, an output device configured to present information, and a processor coupled to the memory, the transceiver, and the output device. The processor may be configured to perform or control performance of receive, a message from the remote server via the transceiver, where the message includes an instruction and at least one criterion extracted from the instruction, and determine whether the stored information in the memory meets the at least one criterion. The processor may also be configured to perform or control performance of, in response to a determination that the stored information meets the at least one criterion, cause the output device to present the instruction to the legitimate agent, and in response to a determination that the stored information fails the at least one criterion, ignore the instruction.

According to some embodiments, the at least one criterion may include conditional information and/or secondary information, where the secondary information modifies the conditional information. The conditional information may include a location, and the secondary information may include a range from the location. The stored information may include information about one or more of a location of the legitimate agent, an assignment of the legitimate agent, equipment of the legitimate agent, a capability of the legitimate agent, a condition of the legitimate agent, an affiliation of the legitimate agent, and an environment that surrounds the legitimate agent.

According to other embodiments, the processor may be further configured to perform or control performance of determining, before the output device is caused to present the instructions, that the legitimate agent is using the agent device. The legitimate agent may be determined to be using the agent device based on one or more of a detected acoustic feature, a password, a biometric signal, a proximity signal, and an illuminance signal. The agent device may include a smartphone, a tablet computer, a wearable computer, a headset, an earpiece, and/or an augmented-reality device.

According to further examples, a method is provided for an agent device to selectively provide instructions to legitimate agents. The method may include receiving a message including an instruction and at least one criterion extracted from the instruction from a remote security server, determining whether a legitimate agent is present, and in response to a determination that the legitimate agent is absent, ignoring the instruction. The method may further include, in response to a determination that the legitimate agent is present, retrieving information associated with the legitimate agent from an agent device memory and determining whether the retrieved information meets the at least one criterion. The method may further include providing the instruction to the legitimate agent in response to a determination that the retrieved information meets the at least one criterion and ignoring the instruction in response to a determination that the retrieved information fails the at least one criterion.

According to some embodiments, the at least one criterion includes conditional information and/or secondary information, where the secondary information modifies the conditional information. The conditional information may include a location, and the secondary information may include a range from the location. The retrieved information may include information about one or more of a location of the legitimate agent, an assignment of the legitimate agent, equipment of the legitimate agent, a capability of the legitimate agent, a condition of the legitimate agent, an affiliation of the legitimate agent, and an environment that surrounds the legitimate agent.

According to other embodiments, determining whether the legitimate agent is present may include determining whether the legitimate agent is present based on one or more of a detected acoustic feature, a password, a biometric signal, a proximity signal, and an illuminance signal. In response to determination that the retrieved information fails the at least one criterion, the method may further include subsequently re-determining whether the legitimate agent is present and whether the information meets the at least one criterion, and determining whether to provide the instruction based on the re-determination. At least the instruction may be cryptographically secured, and providing the instruction may include decrypting the instruction.

According to yet further examples, a security agent system is provided to enable agent devices to selectively output instructions. The security agent system may include multiple field agent devices, a command agent interface configured to receive messages from a command center agent, a criterion extraction module configured to extract at least one criterion from an instruction, a network interface communicatively coupled to the field agent devices, and a processor coupled to the command agent interface, the criterion evaluation module, and the network interface. The processor may be configured to perform or control performance of receive a message including the instruction from the command center agent and via the command agent interface, provide the message to the criterion extraction module, receive the at least one criterion from the criterion extract module, and transmit the message and the at least one criterion to the field agent devices via the network interface. A first one of the field agent devices that satisfies the at least one criterion may be configured to process the message and output the instruction, and a second one of the field agent devices that fails the at least one criterion may be configured to ignore the instruction.

According to some embodiments, the processor may be further configured to perform or control performance of deriving conditional information and/or secondary information from the at least one criterion, where the secondary information is arranged to modify the conditional information, and transmitting, via the network interface, the derived information to the field agent devices. The processor may be further configured to perform or control performance of including, in the conditional information, a location, and including, in the secondary information, a range from the location.

According to other embodiments, the first field agent device may be further configured to determine whether it satisfies the at least one criterion through a comparison of the at least one criterion to information stored by the first field agent device and associated with a legitimate agent. The information may include information about one or more of a location of the legitimate agent, an assignment of the legitimate agent, equipment of the legitimate agent, a capability of the legitimate agent, a condition of the legitimate agent, an affiliation of the legitimate agent, and an environment that surrounds the legitimate agent. The first field agent device may be further configured to determine that a legitimate agent is using the first field agent device before outputting the instruction. The first field agent device may be further configured to determine that the legitimate agent is using the first field agent device based on one or more of a detected acoustic feature, a password, a biometric signal, a proximity signal, and an illuminance signal. The criterion extract module may be configured to extract the at least one criterion from the instruction based on a context of the instruction.

There are various vehicles by which processes and/or systems and/or other technologies described herein may be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for mainly hardware and/or firmware vehicle; if flexibility is paramount, the implementer may opt for mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via application specific integrated circuits (ASICs), field programmable gate arrays (FPGAs), digital signal processors (DSPs), or other integrated formats. However, some aspects of the embodiments disclosed herein, in whole or in part, may be equivalently implemented in integrated circuits, as one or more computer programs executing on one or more computers (e.g., as one or more programs executing on one or more computer systems), as one or more programs executing on one or more processors (e.g., as one or more programs executing on one or more microprocessors), as firmware, or as virtually any combination thereof, and that designing the circuitry and/or writing the code for the software and/or firmware are possible in light of this disclosure.

The present disclosure is not to be limited in terms of the particular embodiments described in this application, which are intended as illustrations of various aspects. Many modifications and variations can be made without departing from its spirit and scope. Functionally equivalent methods and apparatuses within the scope of the disclosure, in addition to those enumerated herein, are possible from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular embodiments only, and is not intended to be limiting.

In addition, the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive (HDD), a compact disc (CD), a digital versatile disk (DVD), a digital tape, a computer memory, a solid state drive (SSD), etc.; and a transmission type medium such as a digital and/or an analog communication medium (e.g., a fiber optic cable, a waveguide, a wired communication link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. A data processing system may include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity of gantry systems; control motors to move and/or adjust components and/or quantities).

A data processing system may be implemented utilizing any suitable commercially available components, such as those found in data computing/communication and/or network computing/communication systems. The herein described subject matter sometimes illustrates different components contained within, or connected with, different other components. Such depicted architectures are merely exemplary, and in fact, many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

For any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. All language such as “up to,” “at least,” “greater than,” “less than,” and the like include the number recited and refer to ranges which can be subsequently broken down into subranges as discussed above. Finally, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments are possible. The various aspects and embodiments disclosed herein are for purposes of illustration and are not intended to be limiting, with the true scope and spirit being indicated by the following claims.

1. A method to enable agent devices to selectively output instructions, the method comprising:
receiving, through a command agent interface at a security server, a message from a command center agent, the message including an instruction;
processing, at the security server, the message to extract at least one criterion from the instruction;
transmitting, through a network interface from the security server, the message to a plurality of field agent devices such that:
the field agent devices process the message,
a first field agent device that satisfies the at least one criterion outputs the instruction, and
a second field agent device that fails the at least one criterion ignores the instruction.

2. The method of claim 1, further comprising:
deriving, at the security server, at least one of a conditional information and a secondary information from the at least one criterion, wherein the secondary information is arranged to modify the conditional information.

3. The method of claim 2, further comprising:
including, in the conditional information, a location; and
including, in the secondary information, a range from the location.

4. The method of claim 1, further comprising:
instructing the first field agent device to determine whether it satisfies the at least one criterion through a comparison of the at least one criterion to information stored by the first field agent device and associated with a legitimate agent, wherein the information includes information about one or more of:
a location of the legitimate agent,
an assignment of the legitimate agent,
an equipment of the legitimate agent,
a capability of the legitimate agent,
a condition of the legitimate agent,
an affiliation of the legitimate agent, or
an environment that surrounds the legitimate agent.

5. (canceled)

6. The method of claim 1, further comprising:
instructing, before outputting the instruction, the first field agent device to determine that a legitimate agent is using the first field agent device based on one or more of a detected acoustic feature, a password, a biometric signal, a proximity signal, or an illuminance signal.

7. (canceled)

8. The method of claim 1, wherein processing the message to extract the at least one criterion includes:
extracting the at least one criterion from the instruction based on a context of the instruction.

9. An agent device configured to selectively present instructions to legitimate agents, the agent device comprising:
a memory configured to store information associated with a legitimate agent;
a transceiver configured to communicate with a remote server;
an output device configured to present information; and
a processor coupled to the memory, the transceiver, and the output device, wherein the processor is configured to perform or control performance of:
receive, via the transceiver, a message from the remote server, wherein the message includes an instruction and at least one criterion extracted from the instruction;
determine whether the stored information in the memory meets the at least one criterion;
in response to a determination that the stored information meets the at least one criterion, cause the output device to present the instruction to the legitimate agent; and
in response to a determination that the stored information fails the at least one criterion, ignore the instruction.

10. The agent device of claim 9, wherein:
the at least one criterion includes at least one of a conditional information and a secondary information, and
the secondary information modifies the conditional information.

11. The agent device of claim 10, wherein the conditional information includes a location, and wherein the secondary information includes a range from the location.

12. The agent device of claim 9, wherein the stored information includes information about one or more of:
a location of the legitimate agent,
an assignment of the legitimate agent,
an equipment of the legitimate agent,
a capability of the legitimate agent,
a condition of the legitimate agent,
an affiliation of the legitimate agent, or
an environment that surrounds the legitimate agent.

13. The agent device of claim 9, wherein the processor is further configured to perform or control performance of:
determine, before the output device is caused to present the instruction, that the legitimate agent is using the agent device.

14. The agent device of claim 13, wherein the legitimate agent is determined to be using the agent device, based on one or more of:
a detected acoustic feature,
a password,
a biometric signal,
a proximity signal, or
an illuminance signal.

15. The agent device of claim 9, wherein the agent device includes one of a smartphone, a tablet computer, a wearable computer, a headset, an earpiece, and an augmented-reality device.

16. A method for an agent device to selectively provide instructions to legitimate agents, the method comprising:
receiving, from a remote security server, a message including an instruction and at least one criterion extracted from the instruction;
determining whether a legitimate agent is present;
in response to a determination that the legitimate agent is absent, ignoring the instruction; and
in response to a determination that the legitimate agent is present:
retrieving information associated with the legitimate agent from an agent device memory;
determining whether the retrieved information meets the at least one criterion;
in response to a determination that the retrieved information meets the at least one criterion, providing the instruction to the legitimate agent; and
in response to a determination that the retrieved information fails the at least one criterion, ignoring the instruction.

17. The method of claim 16, wherein receiving the message including the at least one criterion includes:
receiving at least one of a conditional information and a secondary information, wherein the secondary information modifies the conditional information.

18. The method of claim 17, wherein receiving the conditional information includes receiving a location, and wherein receiving the secondary information includes receiving a range from the location.

19. The method of claim 16, wherein retrieving information associated with the legitimate agent from the agent device memory includes retrieving information about one or more of:
a location of the legitimate agent,
an assignment of the legitimate agent,
an equipment of the legitimate agent,
a capability of the legitimate agent,
a condition of the legitimate agent,
an affiliation of the legitimate agent, or
an environment that surrounds the legitimate agent.

20. The method of claim 16, wherein determining whether the legitimate agent is present includes:
determining whether the legitimate agent is present based on at least one or more of a detected acoustic feature, a password, a biometric signal, a proximity signal, and or an illuminance signal.

21. The method of claim 16, further comprising, in response to determination that the retrieved information fails the at least one criterion:
subsequently re-determining whether the legitimate agent is present and whether the information meets the at least one criterion; and
determining whether to provide the instruction based on the re-determination.

22. The method of claim 16, wherein at least the instruction is cryptographically secured, and wherein providing the instruction includes decrypting the instruction.

23.-30. (canceled)
